(19) United States
(12) Patent Application Publication
(10) Pub. No.: US 2009/0272869 A1
(43) Pub. Date: Nov. 5, 2009

(54) MOTOR DRIVEN LONGITUDINAL ADJUSTMENT DEVICE FOR AN AUTOMOTIVE VEHICLE SEAT

(75) Inventors: Wilfried BENEKER, Leichlingen (DE); Robert LANDSKRON, Monheim am Rhein (DE); Stefan LINGNAU, Solingen (DE)

Correspondence Address: CANTOR COLBURN, LLP, 20 Church Street, 22nd Floor, Hartford, CT, 06103, US

(73) Assignee: C. ROB HAMMERSTEIN GMBH & CO. KG, Solingen (DE)

(21) Appl. No.: 12/349,923

(22) Filed: Jan. 7, 2009

(30) Foreign Application Priority Data
Jan. 8, 2008 (DE) 10 2008 003 362.6

(51) Int. Cl. B60N 2/06

(52) U.S. Cl. 248/429; 296/65.15

(57) ABSTRACT

A longitudinal adjustment device of a motor vehicle seat has a left pair of rails (20), a right pair of rails (22) and an electric motor (24). An adjustment gear (32) is associated with each pair of rails (20, 22). The electric motor (24) has an output shaft (36) connected to the two adjustment gears (32). A motor retaining plate (42) is connected to a seat rail (26) of the left pair of rails (20) and to a seat rail (26) of the right pair of rails (22), receives the electric motor (24) and has a longitudinal direction. The motor retaining plate (42) forms a guide for the output shaft (36) of the electric motor (24), extends parallel to the longitudinal direction of the motor retaining plate (42) and is connected to the adjustment gear (32) of the left pair of rails (20) on one side of the electric motor (24) and to the adjustment gear (32) of the right pair of rails (22) on the other side of the electric motor (24).

### FIELD OF THE INVENTION

The invention relates to a motor-driven longitudinal adjustment device for an automotive vehicle seat.

### BACKGROUND OF THE INVENTION

Such a longitudinal adjustment device is known from U.S. Pat. No. 6,959,900 B2. In this prior art longitudinal adjustment device, the electric motor is disposed parallel to a direction of adjustment of the longitudinal adjustment device in the direction of its length. The electric motor itself is not carried directly by the motor retaining plate but indirectly. On the motor retaining plate there is located a miter gear having two coaxial output shafts running parallel to the y direction and directed in opposite directions. They are partially configured to be an elastic shaft, these shafts are respectively guided about an arc of a circle extending over 90°. The electric motor is disposed on said gear.

The disadvantage thereof is that an intermediate gear is needed to reduce the rpm of the electric motor. As a result, the rpm in the strongly curved elastic shafts is lower than the rpm of the electric motor, but the torques are quite high. As a result, it is quite complicated to configure the elastic shafts.

On the longitudinal adjustment devices according to the documents DE 35 08 515 C2 and DE 68 926 945 T2, the motor is disposed transverse to the adjustment direction of the longitudinal adjustment device. It extends in the y direction. The output shaft is configured on either end of the electric motor, put in other words, the output shaft extends through the electric motor. On the longitudinal adjustment device of DE 68 926 945 T2, the output shaft is only configured as an elastic shaft on one side of the electric motor.

Elastic shafts tend to vibrate in operation. Depending on the load on the automotive vehicle seat, for example through a more or less weighty passenger or in case of no weight load, and also depending on the direction of adjustment, the rpm of the electric motor and the torque to be transmitted change. Under certain conditions, vibrations may occur in the elastic shafts. One already provided the elastic shafts with a flock finish, which is for example applied electrostatically and consists of small hair similar to mouse fur. This allows dampening vibrations.

Thus, it is the object of the invention to avoid the disadvantages of the prior art longitudinal adjustment device and to indicate a longitudinal adjustment device of a simpler construction which tends as least as possible to elastic shaft vibrations and to delivery of disturbing noises.

### BRIEF SUMMARY OF THE INVENTION

In general applicant provides a longitudinal adjustment device of a motor vehicle seat comprising a left pair of rails, a right pair of rails, and an electric motor. Each pair of rails generally comprises a seat rail and a floor rail. An adjustment gear is associated with each pair of rails for allowing movement of a seat rail relative to the corresponding floor rail. The electric motor has an output shaft connected to the two adjustment gears. A motor retaining plate, connected to a seat rail of the left pair of rails and to a seat rail of the right pair of rails, receives the electric motor and has a longitudinal direction. The motor retaining plate forms a guide for the elastic output shaft of the electric motor, extends parallel to the longitudinal direction of the motor retaining plate, and is connected to the adjustment gear of the left pair of rails on one side of the electric motor and to the adjustment gear of the right pair of rails on the other side of the electric motor.

On this longitudinal adjustment device, a guide for the elastic shaft is mounted into the motor retaining plate. This guide can be made from the very material of the retaining plate for the motor. If the motor retaining plate is made from steel sheet, discrete portions can be cut out in the form of tongues and bent so as to form a partial surrounding grip around the elastic shaft. As a result, the elastic shaft can be fixed on purpose on several selected points. As used herein, to fix is understood to refer to the fact that a partial surrounding grip is formed around the flock finish. Accordingly, the fixation does not occur directly on the fixed part of the elastic shaft but forms a surrounding grip around the flock finish. Guidance is all the more effective, the stronger the elastic shaft is deflected at the point of concern. The guide retains the elastic shaft within a hose-shaped channel. It allows for deflections, which it however limits to a certain value of for example 3 mm, 6 mm or 9 mm.

The electric motor is thereby oriented parallel to the y direction in its longitudinal direction. The output shaft, in particular the elastic part of the output shaft, can be implemented without any change in direction. This is meant to exclude small changes in direction by less than 30° for example; in any case, there is no need for great changes in direction.

The electric motor can be located completely above the motor retaining plate. As opposed to the longitudinal adjustment device according to U.S. Pat. No. 6,959,900 B2, the electric motor is indeed carried by the motor retaining plate. As a result, vibrations of the electric motor and the torsion of the motor retaining plate are avoided. Increased efficiency is achieved since there are fewer changes in direction of the participating shafts.

In a preferred developed implementation, the output shaft is only configured to be an elastic shaft or a flexible shaft on one side of the electric motor. The output shaft of the electric motor is understood to be that part of the shaft that rotates with the rpm of the electric motor. The output shaft on the other side of the electric motor can also be configured to be a short piece of elastic shaft although it may also be configured to be a rigid shaft there.

In a preferred developed implementation, the elastic shaft is provided with a flock finish. Such a flock finish belongs to prior art; the reader is referred to DE 103 13 969 A1, merely for him to garner a better understanding. A flexible shaft with a resin coating is known from U.S. Pat. No. 4,915,340 A.

In a preferred developed implementation, the motor retaining plate has a groove in which there is located the elastic shaft. This groove extends parallel to the elastic shaft. The groove extends in a straight line. Preferably, the elastic shaft also extends in a straight line.

Preferably, the guide has arcuate portions which form a surrounding grip around at least part of the elastic shaft. Several arcuate portions are provided, which may be periodically or non-periodically spaced apart.

Preferably, the motor retaining plate is angled twice in one of its end regions at least, which are located in the y direction. As a result, it is possible to fasten the end region to the top of a seat rail and to have the output shaft directly projecting into the seat rail through a window thereof.

Preferably, the electric motor is not disposed in the center between the two pairs of rails; it is rather disposed much closer to the one pair of rails than to the other pair of rails. As a result, a rigid shaft can be inserted on the one side and an elastic shaft on the other side. In addition thereto, the reaction torque of the electric motor is better absorbed than when it is disposed in the center, namely directly on the neighbouring seat rail.

The motor retaining plate is preferably made from one piece. It may be a moulded plastic part but may also be made from a steel sheet blank manufactured by moulding such as by press moulding.

Other features and advantages of the invention will become more apparent upon reviewing the appended claims and the following non restrictive description of one embodiment of the invention, given by way of example only with reference to the drawing.

### BRIEF DESCRIPTION OF THE DRAWINGS

FIG. 1 shows a perspective view of a longitudinal adjustment device with two pairs of rails, one electric motor and one motor retaining plate,

FIG. 2 shows one view to an enlarged scale of the electric motor including the motor retaining plate shown in FIG. 1 and

FIG. 3 shows a sectional view taken along the section line III-III in FIG. 2.

### DETAILED DESCRIPTION OF THE PREFERRED EMBODIMENTS

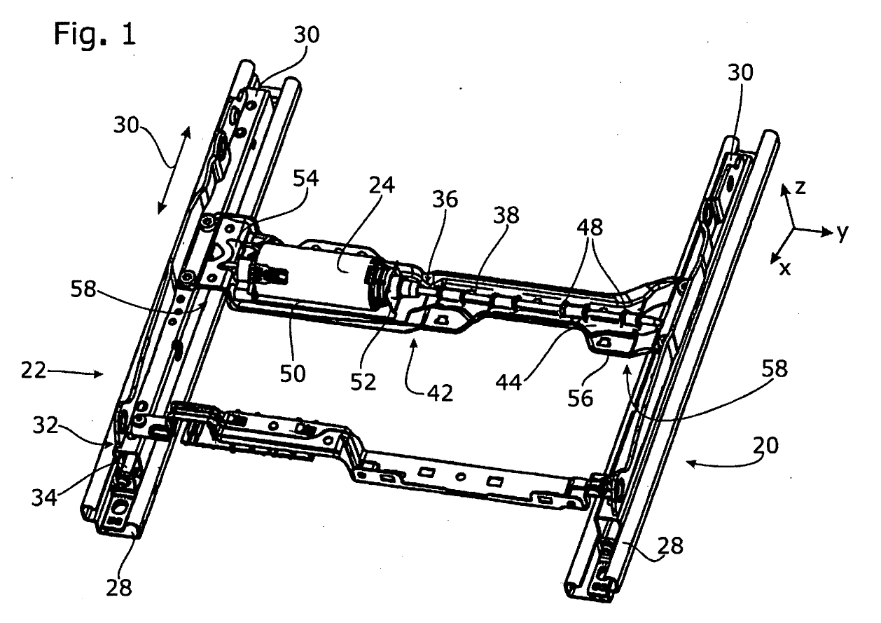

The longitudinal adjustment device as shown in FIG. 1 has a left pair of rails 20 and a right pair of rails 22. It further has an electric motor 24 that is interposed between these two pairs of rails 20, 22 and extends in the y direction, in particular substantially in the y direction. Each pair of rails 20, 22 has one seat rail 26 and one floor rail 28. The floor rail 28 is intended to be fastened to an underbody of a motor vehicle, which is not shown either. The two seat rails 26, 28 are displaceable in one direction of adjustment 30 with respect to the floor rails 28 and carry the remaining parts of the motor vehicle seat. In each pair of rails 20, 22 there is accommodated an adjustment gear 32; in the implementation shown it is housed inside a channel that is open at its end and that extends in the longitudinal direction of the rails and is bounded by said rails 26, 28. The adjustment gear 32 comprises respectively one non-rotatable spindle 34 and one spindle nut (not shown) in engagement therewith. Such type spindle gears are known from US 2006/0260424 A1 and from U.S. Pat. No. 4,802,374 A for example.

The electric motor 24 has an output shaft 36. The output shaft 36 refers to the entire shaft, which rotates at the rpm of the electric motor. In the exemplary embodiment, it is composed of a left rigid part, of a right rigid part, which both preferably directly belong to the electric motor 24, and of one elastic shaft 38. The output shaft 36 extends from the adjustment gear 32 of the left pair of rails 20 to the adjustment gear 32 of the right pair of rails 22. It extends substantially in a straight line, differing by less than 5°. It extends in the y direction. Also the electric motor 24 has its cylindrical motor body oriented in the y direction. The elastic shaft 38 is provided with a radially projecting flock finish 40 of plastic fibers of some millimetres in length. Such type flock finish is prior art.

Between the two seat rails 26, there is disposed a motor retaining plate 42, which extends in the y direction in its longitudinal direction. It is connected to the upper web of the respective one of the seat rails 26 by two screw connections. It is angled twice in proximity to each pair of rails 20, 22, in proximity to the right pair of rails 22, the angle is about 90°, in proximity to the left pair of rails 20, the angle is less; it is about 20 to 50, for example 30°. In both end regions 58, the angle of the two bends is the same. The offset in the z direction due to the two bends is the same on either side, e.g., three cm. As a result, the base 44 of the motor retaining plate 42 is about 10 to 50 mm lower than the plane in which there are located the fixations or the base flanges of the seat rail 26. The base 44 is placed at the very depth necessary for the output shaft 36 to be level with the adjustment gear 32, meaning for it to be capable of directly engaging it.

The output shaft 36 of the electric motor 24 extends parallel to a longitudinal direction of the motor retaining plate 42; this longitudinal direction of the motor retaining plate 42 extends in the y direction. In the region of its base 44, the motor retaining plate 42 has a groove 46 which extends in a semi-circle in profile (see FIG. 3). The center of the semi-circle is formed by the axis of the output shaft 36, see FIG. 3. The groove 46 extends over at least 75% of the overall length of the elastic shaft 38.

The motor retaining plate 42 forms a guide for the output shaft 36, namely for the elastic part, meaning for the elastic shaft 38. For this purpose, arcuate regions 48 are provided, which project from the base 44 and extend over about 180° in the exemplary embodiment. They overlap the elastic shaft 38 and ensure, together with the base 44, a surrounding grip around the elastic shaft 38 over 360° if possible, at least over about 300 to 340°. The surrounding grip is formed around the outer diameter of the elastic shaft 38; this outer diameter is defined by the flock finish 40. The core of the elastic shaft 38, which is shown in a dashed line in FIG. 3, normally does not come into touching contact with the arcuate regions 48 and not with the base 44 either. It can be seen from FIG. 3 that it is spaced a distance apart therefrom, said distance corresponding approximately to the length of the discrete hairs of the flock finish 40.

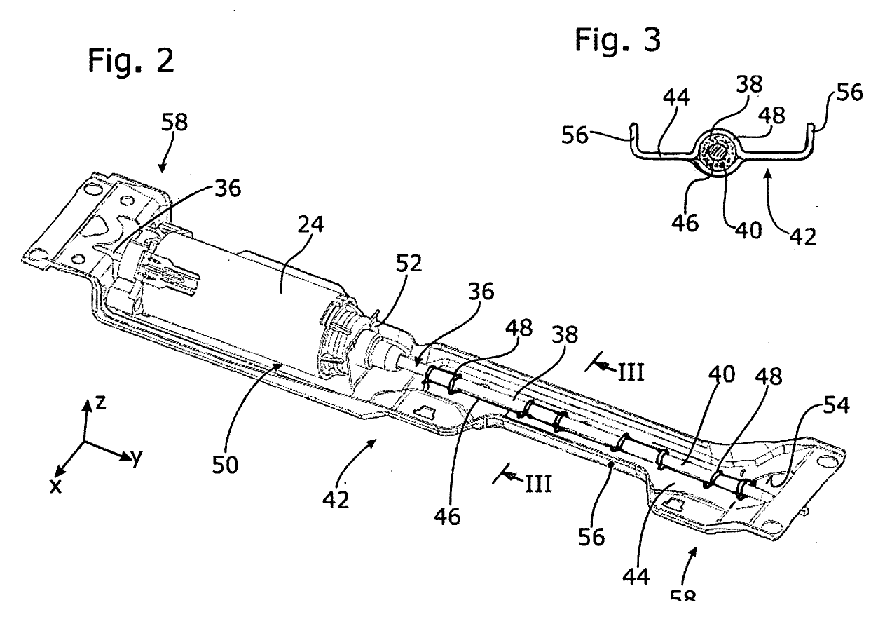

In FIG. 2, there are provided eight arcuate regions 48. They can be disposed any distance apart and be grouped ad lib. In the exemplary embodiment, there are disposed in groups of two. In the groups of two, the arcuate regions 48 are spaced a given distance apart. The groups of two in turn are spaced a given distance apart.

In the exemplary embodiment, the arcuate regions 48 are quite narrow; in the y direction, they extend over 3 through 10 mm. They can be freely formed and can thus be any size.

It is also possible to provide for short tube sections made for example from a plastic tube, said tube sections forming a tube as it is formed through the groove 46 and the arcuate region 48 in the viewing direction of FIG. 3 and to fix these tube sections in a slightly larger groove and in accordingly larger sized arcuate regions 48. The tube sections can be a few millimetres to some centimetres long.

In a preferred implementation, the motor retaining plate 42 is made from one piece. It may for example be made from a steel sheet blank, said steel sheet blank is formed accordingly, such as by pressing. The arcuate regions are made through cut out tongues, said tongues are bent upward. In an implementation made from plastic material the motor retaining plate 42 is preferably made as an injection moulded part of a corresponding shape. To simplify the shape, it is appropriate to provide for a window underneath the respective arcuate regions 48 just like in the steel sheet implementation.

In the y direction the motor retaining plate 42 has its largest extension. In the other directions it is considerably shorter, these dimensions amounting each to 20% at most of the length dimension in the y direction. The motor retaining plate 42 forms a receptacle 50 for the electric motor 24. This plate is preferably in the shape of a trough. In the y direction it is bounded by the bend in the right end region, which has been described, and by a supporting plate 52. The electric motor 24 is located above the motor retaining plate 42. In the x direction and in the y direction it does not project beyond the motor retaining plate 42.

The electric motor 24 is not located in the center between the two pairs of rails 20, 22; instead, it is fastened in immediate proximity to the right pair of rails 22. As a result, the output shaft 36 is significantly shorter on the right seat side than on the left seat side. On the right seat side, the output shaft 36 can be configured to be a rigid shaft; it can also be implemented by a short additional piece of an elastic shaft.

In the end regions 58, more precisely between the two double bends, there is respectively provided a passageway 54 forming a window. The output shaft 36 projects through this passageway 54 on either side thereof The base 44 extends substantially in the y direction and parallel to the output shaft 36, except for the trough for the receptacle 50. In the x direction, the motor retaining plate 42 has a side edge 56 on either longitudinal edge, said side edge standing upright, meaning substantially in the z direction. It is some millimetres in height and forms a bracing. The motor retaining plate 42 generally forms a tie bar that rigidly joins the two seat sides together.

1-16. (canceled)

17. A longitudinal adjustment device of an automotive vehicle seat comprising:
a left pair of rails having a seat rail and a floor rail,
a right pair of rails having a seat rail and a floor rail,
an electric motor, and
an adjustment gear associated with said left pair of rails and an adjustment gear associated with said right pair of rails, each adjustment gear configured to allow adjustable movement of a corresponding seat rail relative to a corresponding floor rail, wherein said electric motor comprises an output shaft connected both to said adjustment gear of said left pair of rails and to said adjustment gear of said right pair of rails,
a motor retaining plate is, said motor retaining plate is configured to be connected to said seat rail of said left pair of rails and to said seat rail of said right pair of rails, accommodate said electric motor, and have a longitudinal direction, wherein said motor retaining plate forms a guide for said output shaft of said electric motor, said output shaft extends parallel to a longitudinal direction of said motor retaining plate and said output shaft is connected to said adjustment gear of said left pair of rails on one side of said electric motor and to said adjustment gear of said right pair of rails on said other side of said electric motor.

18. The longitudinal adjustment device as set forth in claim 17, wherein said output shaft is partially configured to be an elastic shaft.

19. The longitudinal adjustment device as set forth in claim 18, wherein said output shaft is configured to be an elastic shaft on only one side of said electric motor.

20. The longitudinal adjustment device as set forth in claim 17, wherein said elastic shaft is provided with a flock finish.

21. The longitudinal adjustment device as set forth in claim 17, wherein said motor retaining plate comprises a groove extending parallel to at least a part of said output shaft.

22. The longitudinal adjustment device as set forth in claim 21, wherein said groove is semi-circular in profile.

23. The longitudinal adjustment device as set forth in claim 17, wherein said guide comprises arcuate regions forming a partial surrounding grip around at least a part of said output shaft.

24. The longitudinal adjustment device as set forth in claim 17, wherein said output shaft rotates together with the speed of rotation of said electric motor.

25. The longitudinal adjustment device as set forth in claim 17, wherein said motor retaining plate comprises a passageway in at least one end region located in a y direction.

26. The longitudinal adjustment device as set forth in claim 25, wherein said motor retaining plate comprises a passageway for said output shaft in a respective one of said at least one end region.

27. The longitudinal adjustment device as set forth in claim 17, wherein said motor retaining plate comprises a base and at least one side edge, said side edge extending substantially transverse to said base.

28. The longitudinal adjustment device as set forth in claim 27, wherein said side edge extends substantially in a z direction.

29. The longitudinal adjustment device as set forth in claim 17, wherein said motor retaining plate is angled twice in at least one end region located in a y direction.

30. The longitudinal adjustment device as set forth in claim 17, wherein said electric motor is disposed in closer proximity to said one seat rail than to said other seat rail, a distance of said electric motor from said one seat rail being at least 10% smaller than a distance of said electric motor from said other seat rail.

31. The longitudinal adjustment device as set forth in claim 17, wherein said motor retaining plate comprises a receptacle for said electric motor, said receptacle fixing said electric motor.

32. The longitudinal adjustment device as set forth in claim 17, wherein said motor retaining plate has a length measured in a y direction that is at least 3 times its width or thickness.

33. The longitudinal adjustment device as set forth in claim 17, wherein said motor retaining plate has a length measured in a y direction that is at least 5 times its width or thickness

34. The longitudinal adjustment device as set forth in claim 17, wherein said motor retaining plate is made from one of a metal and a plastic material.

35. The longitudinal adjustment device as set forth in claim 17, wherein said motor retaining plate is made from one piece.

36. The longitudinal adjustment device as set forth in claim 17, wherein said electric motor is disposed transverse to an adjustment direction of a length adjustment device.

37. The longitudinal adjustment device as set forth in claim 36, wherein said electric motor is disposed at right angles with respect to said adjustment device.
